(19) United States
(12) Patent Application Publication
(10) Pub. No.: US 2023/0292255 A1
(43) Pub. Date: Sep. 14, 2023

(54) WIRELESS ELECTRONIC DEVICE WITH TOTAL EXPOSURE RATIO (TER) CONTROL AND OPERATION METHOD THEREOF

(71) Applicant: SAMSUNG ELECTRONICS CO., LTD., SUWON-SI (KR)

(72) Inventors: Gangminh Lee, Suwon-si (KR); Hyunseok Yu, Suwon-si (KR)

(21) Appl. No.: 18/179,664

(22) Filed: Mar. 7, 2023

(30) Foreign Application Priority Data
Mar. 10, 2022 (KR) 10-2022-0030329
Jun. 21, 2022 (KR) 10-2022-0075776

(51) Int. Cl. H04W 52/30

(52) U.S. Cl. CPC H04W 52/30

(57) ABSTRACT

An electronic device includes a plurality of antennas, a transmitter configured to be selectively connected to at least one antenna of the plurality of antennas, and a controller configured to set a transmit power limit of the transmitter. The controller is further configured to calculate a residual total exposure ratio (TER) value for a TER measurement period based on transmit power of the transmitter output through the at least one antenna, set a power control mode of the electronic device, based on a comparison between the residual TER value and a first reference TER value, and set the transmit power limit for a target window based on the power control mode.

### CROSS-REFERENCE TO RELATED APPLICATIONS

This application is based on and claims priority under 35 U.S.C. §119 to Korean Patent Application No. 10-2022-0030329 and 10-2022-0075776, respectively filed on Mar. 10, 2022 and Jun. 21, 2022, in the Korean Intellectual Property Office, the disclosures of which are incorporated by reference herein in their entireties.

### Technical Field

The present disclosure relates to controlling a total exposure ratio (TER) in a wireless electronic device.

### Discussion of Related Art

A wireless electronic device may transmit a radio frequency (RF) signal through an antenna to communicate with another device. The electromagnetic waves produced by the transmitted RF signal may have a harmful effect on the human body. To reduce the harmful effect of electromagnetic waves, an authorized agency has regulated a TER measured when the electronic device transmits an RF signal. Therefore, when transmitting an RF signal, the electronic device must satisfy a TER regulation condition. The TER may be calculated by an equation combining Specific Absorption Ratio (SAR) measurements and power density (PD) measurements after normalizing to their respective limits.

For the electronic device to satisfy the TER regulation condition, transmit power at which the electronic device transmits an RF signal may need to be reduced. Such a reduction in transmit power may cause degradation in communication performance of the electronic device. Therefore, a need exists for methods of satisfying the TER regulation condition while minimizing degradation in communication performance of an electronic device.

### SUMMARY

Embodiments of the inventive concept provide an electronic device capable of providing optimal communication performance while satisfying a total exposure ratio (TER) regulation condition.

According to an aspect of the inventive concept, there is provided an electronic device including a plurality of antennas, a transmitter configured to be selectively connected to at least one antenna of the plurality of antennas, and a controller. The controller is configured to: set a transmit power limit of the transmitter; calculate a “residual TER value” for a TER measurement period based on transmit power of the transmitter output through the at least one antenna; set a power control mode of the electronic device, based on a comparison between the residual TER value and a first reference TER value; and set the transmit power limit for a target window based on the power control mode.

According to another aspect of the inventive concept, there is provided an electronic device including a plurality of antennas, a transmitter configured to be selectively connected to at least one of the plurality of antennas, and a controller configured to: set a transmit power limit of the transmitter; set a TER allocation percentage for a plurality of communication networks based at least in part on whether the electronic device is using only one of the communication networks; calculate, for each of the plurality of communication networks, a residual TER value for a TER measurement period, based on transmit power of the transmitter and the TER allocation percentage; set, for each of the plurality of communication networks, a power control mode of the electronic device, based on a comparison of the residual TER value and a first reference TER value; and set, for each of the plurality of communication networks, the transmit power limit for a target window based on the power control mode.

According to another aspect of the inventive concept, there is provided an operation method of an electronic device in which a controller performs operations including: calculating slot TER values based on transmit power of the electronic device; calculating a window TER value by summing together the slot TER values for a plurality of slots included in a window; calculating a residual TER value for a TER measurement period, based on the window TER value and a limited TER value; setting a power control mode of the electronic device, based on a comparison between the residual TER value and a first reference TER value; setting an available TER value for a target window based on the power control mode; and setting the transmit power limit for the target window based on the available TER value for the target window.

### BRIEF DESCRIPTION OF THE DRAWINGS

Embodiments of the inventive concept will be more clearly understood from the following detailed description taken in conjunction with the accompanying drawings in which:

FIG. 1 is a diagram illustrating a wireless communication system including an electronic device according to an embodiment;

FIGS. 2 and 3 are diagrams for explaining a total exposure ratio (TER) measurement period for an electronic device according to an embodiment;

FIG. 4 is a block diagram illustrating a more detailed structure of a controller of an electronic device, according to an embodiment;

FIG. 5 is a flowchart of a method of an operation method of an electronic device, according to an embodiment;

FIG. 6 is a flowchart illustrating in more detail a method, performed by an electronic device, of calculating a residual TER value, according to an embodiment;

FIG. 7 is a flowchart illustrating in more detail a method, performed by an electronic device, of setting a power control mode, according to an embodiment;

FIG. 8 is a flowchart illustrating in more detail a method, performed by an electronic device, of setting an available TER value when a power control mode is a saving mode, according to an embodiment;

FIG. 9 is a block diagram illustrating a more detailed structure of a controller of an electronic device, according to another embodiment;

FIG. 10 is a flowchart of an operation method of an electronic device, according to another embodiment;

FIGS. 11 and 12 are flowcharts illustrating in more detail a method, performed by an electronic device, of setting a TER allocation percentage, according to another embodiment;

FIG. 13 is a flowchart of an operation when an electronic device is operating in a limited power mode, according to another embodiment; and

FIG. 14 is a block diagram of a wireless communication equipment according to an embodiment.

### DETAILED DESCRIPTION OF EMBODIMENTS

Hereinafter, embodiments will be described in detail with reference to the accompanying drawings.

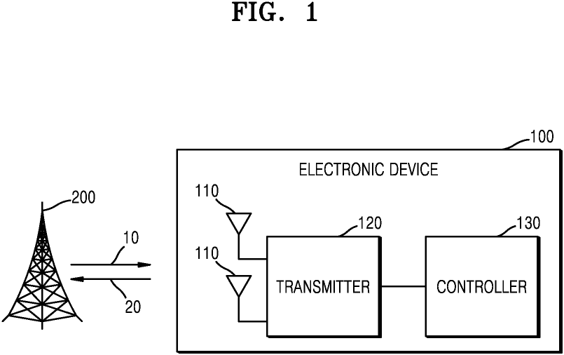

FIG. 1 is a diagram illustrating a wireless communication system including an electronic device according to an embodiment.

Referring to FIG. 1, the wireless communication system may include an electronic device 100 and a base station 200. The electronic device 100 and the base station 200 may communicate through a downlink channel 10 and an uplink channel 20.

The electronic device 100 may be a device capable of performing wireless communication, may be stationary or mobile, and may be any one of various devices capable of transmitting and receiving data and control information by communicating with the base station 200. The electronic device 100 may also be referred to as a terminal equipment, a mobile station (MS), a mobile terminal (MT), a user terminal (UT), a subscriber station (SS), a wireless device, a handheld device, or the like.

The base station 200 may generally refer to a fixed station that communicates with the electronic device 100 and other base stations, and exchange data and control information by communicating with the electronic device 100 and the other base stations. The base station 200 may also be referred to as a Node B, an evolved Node B (eNB), a base transceiver system (BTS), an access point (AP), or the like.

A wireless communication network between the electronic device 100 and the base station 200 may support communication by multiple users by sharing available network resources among the users. For example, in a wireless communication network, information may be transmitted using various methods, such as code division multiple access (CDMA), frequency division multiple access (FDMA), time division multiple access (TDMA), orthogonal frequency division multiple access (OFDMA), single carrier FDMA (SC-FDMA), etc.

The electronic device 100 may include a plurality of antennas 110, a transmitter 120, and a controller 130.

The antenna 110 may transmit an RF signal through the uplink channel 20 and receive an RF signal through the downlink channel 10.

The transmitter 120 may be selectively connected to at least one of the plurality of antennas 110. The transmitter 120 may output transmit power to the antenna 110 to transmit an RF signal via the antenna 110.

The controller 130 may adjust the transmit power of the transmitter 120. In other words, the controller 130 may adjust the transmit power of the transmitter 120 so that a desired RF signal may be finally output via the antenna 110. In an embodiment, the controller 130 may directly adjust the transmit power of the transmitter 120, and in another embodiment, the controller 130 may control the transmit power of the transmitter 120 through a separate power management integrated circuit (PMIC).

The controller 130 may be implemented using a processor, a numeric processing unit (NPU), a graphics processing unit (GPU), or the like.

The controller 130 may set a transmit power limit of the transmitter 120. The controller 130 may control the transmitter 120 to transmit an RF signal at transmit power that is less than or equal to the transmit power limit.

The transmit power of the transmitter 120 may be adjusted based on an uplink transmit power control (TPC) command transmitted from the base station 200 to the electronic device 100 through the downlink channel 10. For example, to keep a signal-to-interference ratio (SIR) of an RF signal received from the electronic device 100 at a target level, the base station 200 may transmit a TPC command to the electronic device 100 based on estimated SIR. The electronic device 100 may then adjust, based on the TPC command received via the controller 130, transmit power of RF signals transmitted to the base station 200 through the uplink channel 20.

The transmit power of the transmitter 120 may be related to energy radiated from the electronic device 100. That is, strong electromagnetic waves may be generated from the electronic device 100 by radio frequency (RF) signals generated with high transmit power and the electromagnetic waves may have a harmful effect on a user. The harmful effect of such electromagnetic waves on the user may be measured through a specific absorption percentage (SAR) or a power density (PD). In addition, the SAR and the PD measured when the electronic device 100 transmits an RF signal may be limited using a total exposure ratio (TER) value regulation condition, and the TER value regulation condition may be defined as shown in Equation 1 below:

$$T E R = {\sum }_{n = 0}^{N - 1} \frac{S A {R}_{a v r , n}}{S A {R}_{l i m i t}} + {\sum }_{m = 0}^{M - 1} \frac{P {D}_{a v r , m}}{P {D}_{l i m i t}} < 1 \qquad \text{[Equation 1]}$$

In Equation 1, SARₗᵢₘᵢₜ denotes a SAR limit that may be determined by an authorized agency, SAR_{avr,n} denotes an average of SAR values measured during an n-th measurement period, PDₗᵢₘᵢₜ denotes a PD limit that may be determined by the authorized agency, and PD_{avr,m} denotes an average of PD values measured during an m-th measurement period.

The SAR and PD may each be calculated by using commonly known mathematical formulas. In this case, SAR and PD may be proportional to transmit power of the electronic device 100. Because the TER is calculated as the sum of the SAR and the PD, the TER may be proportional to the transmit power of the electronic device 100. Therefore, by increasing or decreasing the transmit power of the electronic device 100, a TER measured when the electronic device 100 transmits an RF signal may be increased or decreased.

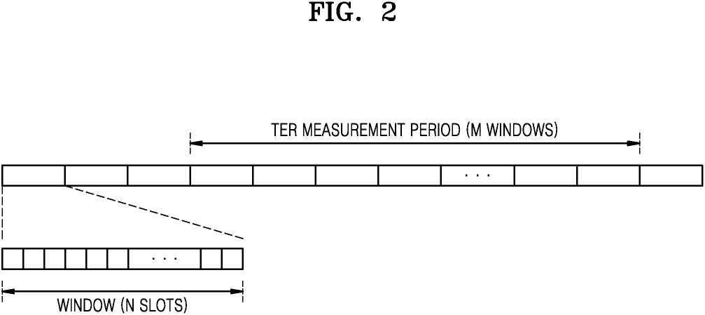

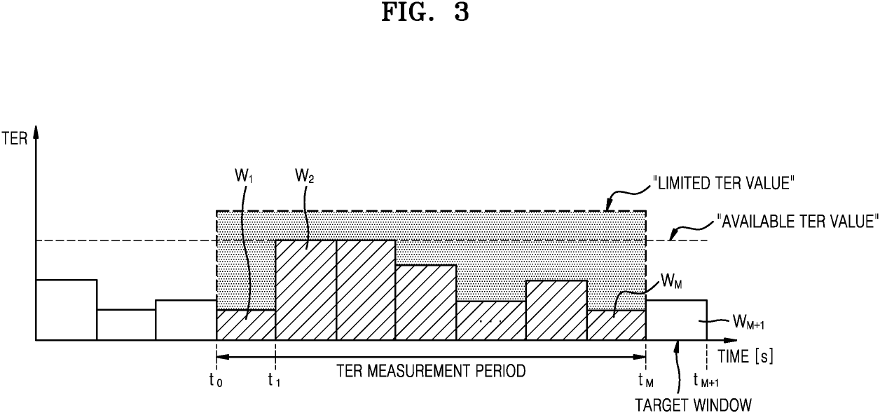

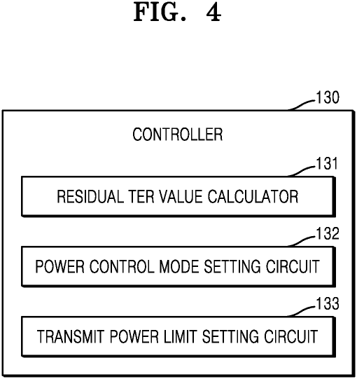

To satisfy the TER regulation condition as defined by Equation 1 above, the controller 130 of the electronic device 100 according to an embodiment may set a transmit power limit of the transmitter 120. To this end, the controller 130 may calculate what is herein defined as a “residual TER value” for a TER measurement period based on transmit power of the transmitter 120, set a power control mode of the electronic device 100, based on a comparison of the residual TER value and a first reference TER value, and set, based on the power control mode, a transmit power limit for a “target window”. Briefly, a residual TER value may be a measure of how close a TER measured over a TER measurement period is to a previously set “limited TER” (e.g., a maximum TER). A TER measurement period and a target window are described in more detail below with reference to FIGS. 2 and 3, and an operation of the controller 130 is described below in more detail with reference to FIGS. 4 to 13.

FIGS. 2 and 3 are diagrams for explaining a TER measurement period for an electronic device according to an embodiment.

Referring to FIG. 2, it can be seen that a plurality of blocks are arranged in a horizontal direction, which is a time direction. Each of the blocks at the top of FIG. 2 may represent a window. Each window may have a preset time period. In an example, a window may have a time period of 250 ms.

As seen through a block at the bottom of FIG. 2, one window may be subdivided into N slots. A slot may represent a time unit for transmitting a plurality of communication symbols.

In an embodiment, the controller 130 may calculate a TER based on the transmit power of the transmitter 120 in units of slots, and a “slot TER value” may mean a TER calculated for any given slot.

A TER measurement period may refer to a period in which a TER is measured for the purpose of determining whether a TER regulation condition is satisfied. The TER measurement period may include M windows.

The TER measurement period may be set based on a communication frequency band for the electronic device 100. For example, when the communication frequency band for the electronic device 100 is lower than 3 gigahertz (GHz), the TER measurement period may be 100 s and include 400 windows. When the communication frequency band for the electronic device 100 is higher than or equal to 3 GHz but lower than 6 GHz, the TER measurement period may be 60 s and include 240 windows. When the communication frequency band for the electronic device 100 is higher than or equal to 6 GHz, the TER measurement period may be 4 s, and may include 16 windows.

FIG. 3 illustrates a histogram graph of TER values measured over time. In the graph of FIG. 3, the horizontal axis represents time, the vertical axis represents a TER value, and each interval may correspond to one window. In this case, a “window TER value”, which indicates a TER value calculated for one window, may be calculated by summing together slot TER values for a plurality of slots included in the window.

According to an embodiment, the electronic device 100 may calculate a residual TER value, based on a comparison between window TER values and a “limited TER value”, during the TER measurement period. The limited TER value may indicate a maximum TER value that is permissible during the TER measurement period. In addition, the electronic device 100 may set, based on the residual TER value, an “available TER value”, which is a maximum TER applicable to signal energy of a target window in a period immediately following the TER measurement period.

After setting the available TER value for the target window, the electronic device 100 may include the window in an updated TER measurement period. The electronic device 100 may exclude, from the updated TER measurement period, an oldest one among the plurality of windows included in the previous TER measurement period. The electronic device 100 may then set, as a next target window, a window within a period immediately following the updated TER measurement period, and set an available TER value for the next target window based on a residual TER determined for the updated TER measurement period.

For example, in FIG. 3, a first TER measurement period may be the period from time t₀ to time t_{M} and encompass windows W₁ through W_{M}. A limited TER value may have been set in advance for the first TER measurement period. A first residual TER value may be computed as a difference between the limited TER value and a summation of measured TERs for the windows W₁ to W_{M}. The first residual TER value may be used to generate a first available TER value for the target window, W_{M+1}, which may occur between times t_{M} and t_{M+1}. Thereafter, a second TER measurement period may be the period between times t₁ and t_{M+1}, which includes the window W_{M+1} in place of the window W₁. A second residual TER value may then be computed for the second TER measurement period to arrive at a second available TER value corresponding to a target window succeeding the window W_{M}. In the second TER measurement period, the same limited TER value may be used to determine the second residual TER value.

FIG. 4 is a block diagram illustrating a more detailed structure of a controller of an electronic device, according to an embodiment.

Referring to FIG. 4, the controller 130 may include a residual TER value calculator 131, a power control mode setting circuit 132, and a transmit power limit setting circuit 133.

The residual TER value calculator 131 may calculate a residual TER value for a TER measurement period based on transmit power of the transmitter 120. The residual TER value may be a value indicating how much less a TER value used is than a limited TER value during the TER measurement period.

In detail, the residual TER value calculator 131 may calculate a slot TER value based on the transmit power of the transmitter 120. The residual TER value calculator 131 may identify the transmit power of the transmitter 120 in a slot for which a slot TER value is to be calculated, and calculate the slot TER value based on the transmit power.

The residual TER value calculator 131 may calculate a window TER value based on a plurality of slot TER values. The residual TER value calculator 131 may calculate a window TER value by summing together the slot TER values for a plurality of slots included in a window for which the window TER value is to be calculated.

The residual TER value calculator 131 may calculate a residual TER value, based on a plurality of window TER values, and a limited TER value.

The residual TER value calculator 131 may calculate an accumulated TER value based on a plurality of window TER values. The accumulated TER value may be a value obtained by accumulating TER values used during a TER measurement period. The residual TER value calculator 131 may calculate the accumulated TER value by adding up window TER values respectively corresponding to a plurality of windows included in the TER measurement period. In addition, the residual TER value calculator 131 may calculate the residual TER value by subtracting the accumulated TER value from the limited TER value.

The power control mode setting circuit 132 may set a power control mode of the electronic device 100, based on the residual TER value and a first reference TER value. The first reference TER value may refer to a value used as a reference in determining whether the TER value regulation condition is satisfied even when a high TER value is used in a target window. For example, the first reference TER value may be set to 10% of the limited TER value.

In detail, when the residual TER value is greater than or equal to the first reference TER value, the power control mode setting circuit 132 may set a power control mode based on a change in window TER values within the TER measurement period.

The change in window TER values within the TER measurement period may indicate whether the window TER values are increasing or decreasing during the TER measurement period. The change in window TER values within the TER measurement period may be determined based on an overall increase/decrease in window TER values, a window TER value for an oldest window among a plurality of windows within the TER measurement period, etc.

The change in window TER values within the TER measurement period may be calculated based on the window TER values, a correlation coefficient between antennas 110 included in the electronic device 100, and a back-off TER value.

The correlation coefficient between the antennas 110 may be a coefficient for compensating for a difference that occurs when a first antenna used at a first interval in the TER measurement period differs from a second antenna used at a second interval occurring after the first interval. In other words, the correlation coefficient between the antennas may be a coefficient for compensating for a difference in TER values that occurs because the first antenna and the second antenna transmit signals in different directions. Therefore, when a window TER value is calculated based on the second antenna, a window TER value calculated when the first antenna is used may be reduced or increased by multiplying a TER value calculated based on the first antenna by the correlation coefficient between the antennas.

The back-off TER value may refer to a minimum TER value considered to be used in a window. Therefore, when a window TER value for a particular window among the windows within the TER measurement period is less than a back-off TER value, the back-off TER value may be used instead of the window TER value for the corresponding window when determining a change in window TER values within the TER measurement period.

The power control mode setting circuit 132 may set a pre-power saving mode (“pre-saving mode”) as the power control mode when a window TER value is increasing within the TER measurement period. The pre-saving mode may be a mode for limiting the use of transmit power in advance in a case where the TER value regulation condition is satisfied even when a lot of power is used during a target window but it is highly likely that the TER value regulation condition is not satisfied over time. Accordingly, even when the residual TER value is greater than or equal to the first reference TER value, the power control mode setting circuit 132 may set the pre-saving mode as the power control mode when a window TER value is increasing within the TER measurement period.

The power control mode setting circuit 132 may set a maximum power mode as the power control mode when a window TER value is decreasing within the TER measurement period. The maximum power mode may be a mode that allows transmit power to be used as much as necessary in a case where the TER value regulation condition is satisfied even when a lot of power is used during a target window and the TER value regulation condition is also likely to be satisfied over time. Accordingly, the power control mode setting circuit 132 may set the maximum power mode as the power control mode when the residual TER value is greater than or equal to the first reference TER value and a window TER value is decreasing within the TER measurement period.

When the residual TER value is less than the first reference TER value, the power control mode setting circuit 132 may set a power saving mode (“saving mode”) as the power control mode. The power control mode may be a mode for limiting the use of transmit power when excessive power is used in a target window and thus it is highly likely that the TER value regulation condition is not satisfied.

The transmit power limit setting circuit 133 may set a transmit power limit for a target window based on a power control mode set by the power control mode setting circuit 132.

In detail, the transmit power limit setting circuit 133 may set an available TER value for a target window based on a power control mode.

When the power control mode is a saving mode, the transmit power limit setting circuit 133 may determine what percentage of the limited TER value corresponds to the residual TER value and set the available TER value to a value between a minimum TER value and a back-off TER value. The minimum TER value may be a TER value corresponding to a minimum transmit power required for transmission of a signal via the antenna 110.

The transmit power limit setting circuit 133 may set an available TER value, based on the second reference TER value and the third reference TER value. The second reference TER value and the third reference TER value may be values used as a reference in determining how much transmit power the electronic device 100 is to be saved in the saving mode and in setting the available TER value. In this case, the second reference TER value and the third reference TER value may both be less than the first reference TER value. For example, the first reference TER value may correspond to 10% of the limited TER value, the second reference TER value may correspond to 9% of the limited TER value, and the third reference TER value may correspond to 3% of the limited TER value.

When the power control mode is the saving mode and the residual TER value is greater than or equal to the second reference TER value, the transmit power limit setting circuit 133 may set a back-off TER value as an available TER value. When the power control mode is the saving mode and the residual TER value is less than the second reference TER value but greater than or equal to the third reference TER value, the transmit power limit setting circuit 133 may set, as an available TER value, a value obtained by multiplying a back-off TER value by a ratio of the residual TER to the first reference TER value. When the residual TER value is less than the third reference TER value, the transmit power limit setting circuit 133 may set a minimum TER value as the available TER value.

When the power control mode is a pre-saving mode. the transmit power limit setting circuit 133 may set a back-off TER value as an available TER value. That is, even when the residual TER value is greater than or equal to the first reference TER value, in the pre-saving mode, the transmit power limit setting circuit 133 may set a back-off TER value as an available TER value instead of a required TER value, thereby preventing occurrence of a situation in which the TER value regulation condition is not satisfied.

When the power control mode is a maximum power mode, the transmit power limit setting circuit 133 may set a required TER value as an available TER value. The required TER value may be a TER value corresponding to a maximum value of transmit power required when the electronic device 100 transmits a signal via the antenna 110. When the electronic device 100 transmits a signal using the transmit power corresponding to the required TER value, optimal communication performance may be achieved.

The transmit power limit setting circuit 133 may set a transmit power limit based on an available TER value. The transmit power limit setting circuit 133 may set a transmit power limit by using Equation 1 and commonly known mathematical formulas for calculating SAR values and PD values.

When the electronic device 100 according to an embodiment as described above is used, optimal communication performance may be provided while satisfying the TER value regulation condition by calculating a residual TER value for a TER measurement period, setting a power control mode based on a first reference TER value and a change in window TER values, and setting a transmit power limit based on the power control mode.

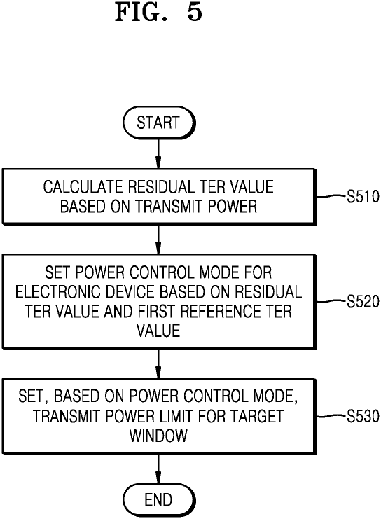

FIG. 5 is a flowchart of a method of an operation method of an electronic device, according to an embodiment.

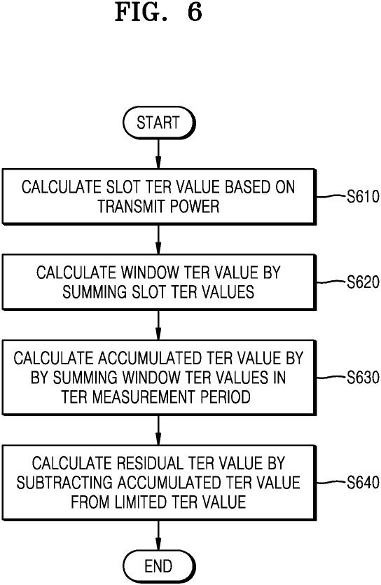

Referring to FIG. 5, in operation S510, the controller 130 may calculate a residual TER value based on transmit power. A method, performed by the controller 130, of calculating a residual TER value may be as shown in more detail in FIG. 6.

FIG. 6 is a flowchart illustrating in more detail a method, performed by an electronic device, of calculating a residual TER value, according to an embodiment.

Referring to FIG. 6, in operation S610, the controller 130 may calculate a slot TER value based on transmit power of the transmitter 120. The controller 130 may calculate a slot TER value by using Equation 1 above and commonly known mathematical formulas for calculating SAR values and PD values.

In operation S620, the controller 130 may calculate a window TER value by summing together a plurality of slot TER values. The controller 130 may calculate a window TER value by summing together a plurality of slot TER values included in the same window.

In operation S630, the controller 130 may calculate an accumulated TER value by summing together a plurality of window TER values within a TER measurement period. For example, when one window has a length of 250 ms and the TER measurement period has a length of 100 s, the controller 130 may calculate an accumulated TER value by summing together 400 window TER values respectively corresponding to 400 windows included in the TER measurement period.

In operation S640, the controller 130 may calculate a residual TER value by subtracting the accumulated TER value from a limited TER value.

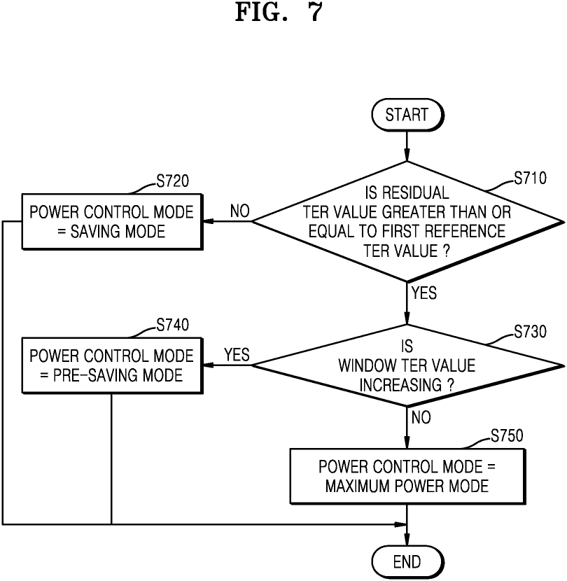

Returning to FIG. 5, in operation S520, the controller 130 may set a power control mode of the electronic device 100, based on the residual TER value and a first reference TER value. A method, performed by the controller 130, of setting a power control mode is described in more detail with reference to FIG. 7.

FIG. 7 is a flowchart illustrating in more detail a method, performed by an electronic device, of setting a power control mode, according to an embodiment.

Referring to FIG. 7, in operation S710, the controller 130 may determine whether the residual TER value is greater than or equal to the first reference TER value.

When it is determined that the residual TER value is less than the first reference TER value, the controller may perform operation S720 to set a saving mode as a power control mode.

When it is determined that the residual TER value is greater than or equal to the first reference TER value, the controller 130 may perform operation S730 to determine whether a window TER value is increasing.

When it is determined that the window TER value is increasing, the controller 130 may perform operation S740 to set a pre-saving mode as the power control mode.

When it is determined that the window TER value is decreasing, the controller 130 may perform operation S750 to set a maximum power mode as the power control mode.

Referring back to FIG. 5, in operation S530, the controller 130 may set, based on the power control mode, a transmit power limit for a target window.

First, the controller 130 may set, based on the power control mode, an available TER value for the target window.

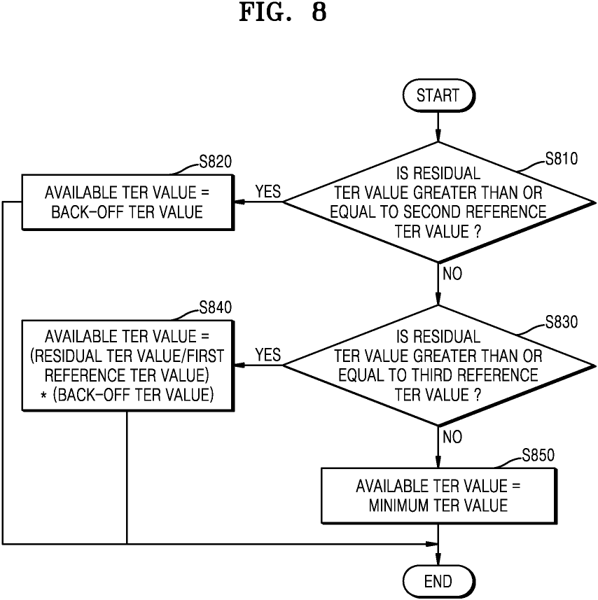

When the power control mode is the saving mode, the controller 130 may set an available TER value, based on a second reference TER value and a third reference TER value. A method, performed by the controller 130, of setting an available TER value when the power control mode is the saving mode may be as shown in more detail in FIG. 8.

FIG. 8 is a flowchart illustrating in more detail a method, performed by an electronic device, of setting an available TER value when a power control mode is a saving mode, according to an embodiment.

Referring to FIG. 8, in operation S810, the controller 130 may determine whether the residual TER value is greater than or equal to the second reference TER value.

When it is determined that the residual TER value is greater than or equal to the second reference TER value, the controller 130 may perform operation S820 to set a back-off TER value as an available TER value.

When it is determined that the residual TER value is less than the second reference TER value, the controller 130 may perform operation S830 to determine whether the residual TER value is greater than or equal to the third reference TER value.

When it is determined that the residual TER value is greater than or equal to the third reference TER value, the controller 130 may perform operation S840 to set, as an available TER value, a value obtained by multiplying the back-off TER value by a ratio of the residual TER value to the first reference TER value.

When it is determined that the residual TER value is less than the third reference TER value, the controller 130 may perform operation S850 to set a minimum TER value as an available TER value.

Returning to FIG. 7, when the power control mode is a pre-saving mode (operation S740), the controller 130 may set the back-off TER value as an available TER value. Furthermore, when the power control mode is a maximum power mode, the controller 130 may set the available TER value to a specification-compliant (e.g., regulation) TER value.

Then, the controller 130 may set, based on the available TER value for a target window, a transmit power limit for the target window.

When the operation method of the electronic device 100 according to an embodiment as described above is used, optimal communication performance may be provided while satisfying the TER value regulation condition by setting a transmit power limit based on a residual TER value and a change in window TER values within a TER measurement period.

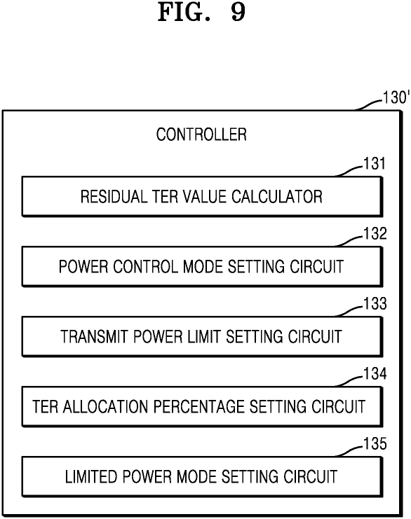

FIG. 9 is a block diagram illustrating a more detailed structure of a controller, 130′, of an electronic device, according to another embodiment. The controller 130′ is an example of the controller 130 of FIG. 1.

Referring to FIG. 9, according to another embodiment, the controller 130′ of the electronic device 100 may include a residual TER value calculator 131, a power control mode setting circuit 132, a transmit power limit setting circuit 133, a TER allocation percentage setting circuit 134, and a limited power mode setting circuit 135.

The limited power mode setting circuit 135 may operate before the TER allocation percentage setting circuit 134, the residual TER value calculator 131, the power control mode setting circuit 132, and the transmit power limit setting circuit 133 operate. The limited power mode setting circuit 135 may determine whether the electronic device 100 is operating in a limited power mode. The limited power mode setting circuit 135 may determine that the electronic device 100 is operating in the limited power mode when the electronic device 100 needs to maintain consistent communication quality as in a call mode.

When the electronic device 100 is operating in the limited power mode, the limited power mode setting circuit 135 may set preset reference transmit power as a transmit power limit. For example, the reference transmit power may be transmit power corresponding to a back-off TER value.

The TER allocation percentage setting circuit 134 may set TER allocation percentages for a plurality of communication networks based on whether the electronic device 100 is using one communication network.

A communication network may be a network for communication between the electronic device 100 and the base station 200, between the electronic devices 100, or between the base stations 200 by using a fifth generation (5G) (or new radio (NR)), long term evolution (LTE), LTE-advanced (LTE-A), WiMAX, WiFi, CDMA, global system for mobile communications (GSM), wireless local area network (WLAN), or any other suitable wireless communication technology.

A TER allocation percentage may be a percentage indicating a TER value that is usable by each of a plurality of communication networks from among all available TER values. For example, when the electronic device 100 sets a TER allocation percentage for a first communication network to 60% and a TER allocation percentage for a second communication network to 40%, the first communication network may use transmit power corresponding to a maximum of 60% of the limited TER value, and the second communication network may use transmit power corresponding to a maximum of 40% of the limited TER value.

When the electronic device 100 is using only one communication network, the TER allocation percentage setting circuit 134 may determine whether the electronic device 100 is operating in a dual SIM mode. The dual SIM mode may be a mode in which the electronic device 100 accesses and uses each of a plurality of communication networks via a separate SIM.

When the electronic device 100 is operating in the dual SIM mode, the TER allocation percentage setting circuit 134 may set a preset dual SIM TER allocation percentage as a TER allocation percentage. In this case, even when the electronic device 100 is using one communication network, the dual SIM TER allocation percentage may be set such that a TER allocation percentage of the communication network being used is not set to 100% but instead a part of the limited TER value is allocated to a communication network not being used, e.g., by setting the TER allocation percentage of the communication network being used to 75% and the TER allocation percentage of the communication network not being used to 25%. This is because the speed of information exchange between different SIMs in the dual SIM mode is low.

When it is determined that the electronic device is not operating in the dual SIM mode, the TER allocation percentage setting circuit 134 may set a TER allocation percentage by taking into account the effect of a communication network not being used.

For example, in a case where a communication network that is not being used has never been used during the TER measurement period, the TER allocation percentage setting circuit 134 may set a TER allocation percentage of the communication network being used to 100% while setting a TER allocation percentage of the communication network not being used to 0%. On the other hand, when the communication network that is not being used has been used during the TER measurement period, the TER allocation percentage setting circuit 134 may set the TER allocation percentage of the communication network not being used to a value other than 0%, based on a TER allocation percentage in a window immediately preceding a target window. For example, when the TER allocation percentage of a communication network used in the window immediately preceding the target window is 85%, the TER allocation percentage setting circuit 134 may set the TER allocation percentage of the communication network being used in the target window to a value, e.g., 90%, slightly higher than the TER allocation percentage in the immediately preceding window.

When the electronic device 100 is using a plurality of the communication networks, the TER allocation percentage setting circuit 134 may set TER allocation guide percentages for the plurality of communication networks based on TER usage percentages for the plurality of communication networks in a window preceding the target window. A TER allocation guide percentage may be a percentage used as a reference in setting a TER allocation percentage. When a TER usage percentage for the first network is 35% and a TER usage percentage of the second network is 55% in the window preceding the target window, the TER allocation percentage setting circuit 134 may set a TER allocation guide percentage for the first network to 40% and a TER allocation guide percentage for the second network to 60%.

When the electronic device 100 is using a plurality of communication networks, the TER allocation percentage setting circuit 134 may set a TER allocation percentage for each of the communication networks, based on a corresponding TER allocation guide percentage and whether the TER allocation percentage keeps converging.

Whether the TER allocation percentage keeps converging may be determined based on whether the TER allocation percentage has converged in a plurality of windows within the TER measurement period.

When the TER allocation percentage does not keep converging while the electronic device 100 is using the plurality of communication networks, the TER allocation percentage setting circuit 134 may set the TER allocation percentage by adjusting a TER allocation guide percentage. In other words, the TER allocation percentage setting circuit 134 may set the TER allocation percentage to converge over time.

When the TER allocation percentage keeps converging while the electronic device 100 is using the plurality of communication networks, the TER allocation percentage setting circuit 134 may set a TER allocation guide percentage as the TER allocation percentage.

The TER allocation percentage setting circuit 134 may set an instantaneous maximum TER value and a controlled TER value for each of the communication networks.

The instantaneous maximum TER value may be a TER value corresponding to a maximum transmit power required for transmission of a signal via the antenna 110, and may be adjusted and set for each of the communication networks according to a corresponding TER allocation percentage.

The controlled TER value is a value indicating whether additional adjustment is required with respect to an available TER value, and may be set to a certain percentage (e.g., 50%) of the instantaneous maximum TER value.

The residual TER value calculator 131 may calculate, for each of the communication networks, a residual TER value for a TER measurement period based on transmit power of the transmitter 120 and a TER allocation percentage. In other words, the residual TER value calculator 131 may separately calculate a residual TER value corresponding to a TER measurement period for each of the communication networks.

In detail, for each of the communication networks, the residual TER value calculator 131 may calculate a slot TER value based on the transmit power of the transmitter 120 and calculate a window TER value by summing together slot TER values for a plurality of slots included in a window.

The residual TER value calculator 131 may calculate, for each of the communication networks, a residual TER value, based on a TER allocation percentage, window TER values, and a limited TER value. For each of the communication networks, the residual TER value calculator 131 may calculate an accumulated TER value by summing together window TER values for a plurality of windows included in the TER measurement period and then calculate a residual TER value by subtracting the accumulated TER value from a value obtained by multiplying a TER allocation percentage of the corresponding communication network by the limited TER value. Thus, unlike the embodiment described with reference to FIGS. 4 to 8, the residual TER value calculator 131 may separately calculate a residual TER value for each of the communication networks by using a value obtained by multiplying a corresponding TER allocation percentage by the limited TER value instead of just using the limited TER value.

The power control mode setting circuit 132 may set, for each of the communication networks, a power control mode of the electronic device 100, based on the residual TER value and the first reference TER value.

The power control mode setting circuit 132 may separately set a power control mode for each of the communication networks. For example, the power control mode setting circuit 132 may set a power control mode for the first communication network to a saving mode and a power control mode for the second communication network to a maximum power mode.

A method, performed by the power control mode setting circuit 132, of setting a power control mode may be substantially the same as that described above with reference to FIGS. 4 to 8.

The transmit power limit setting circuit 133 may set, for each of the communication networks, a transmit power limit for a target window based on a power control mode.

In detail, for each of the communication networks, the transmit power limit setting circuit 133 may set an available TER value for the target window based on the power control mode and set a transmit power limit based on the available TER value. Thus, the transmit power limit setting circuit 133 may separately set a transmit power limit for each of the communication networks.

A method, performed by the transmit power limit setting circuit 133, of setting a transmit power limit may be substantially the same as that described above with reference to FIGS. 4 to 8.

After setting an available TER value for each of the communication networks based on a power control mode therefor, the transmit power limit setting circuit 133 may reset a minimum value among the available TER value, an instantaneous maximum TER value, and a controlled TER value as an available TER value for the corresponding communication network.

When the electronic device 100 according to the embodiment of FIG. 9 as described above is operated, even in the case of simultaneously using a plurality of communication networks, optimal communication performance may be provided while satisfying the TER value regulation condition by setting a transmit power limit based on a TER allocation percentage.

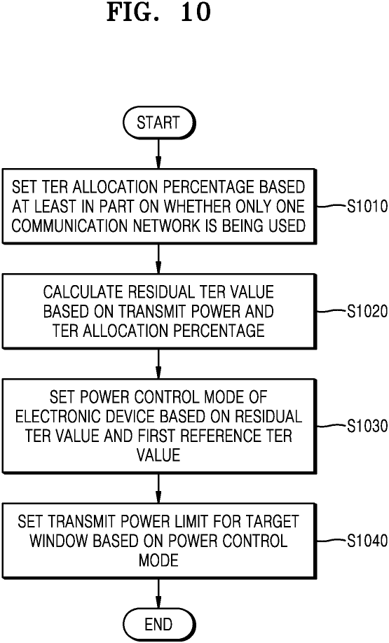

FIG. 10 is a flowchart of an operation method of an electronic device including the above-described controller 130′, according to another embodiment.

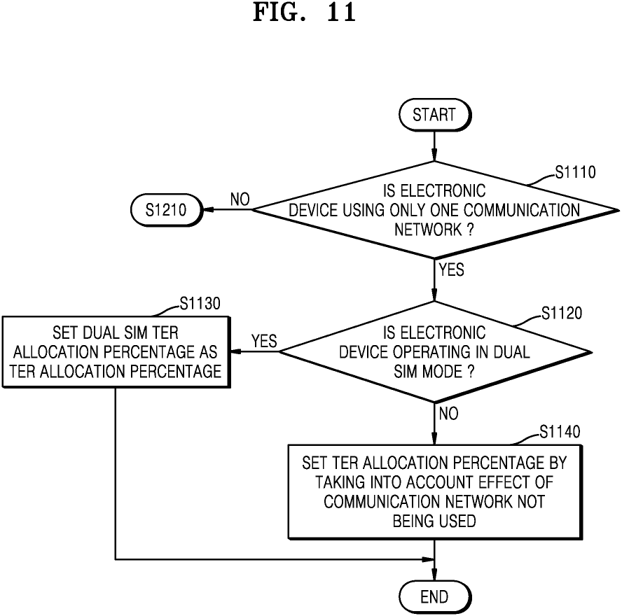

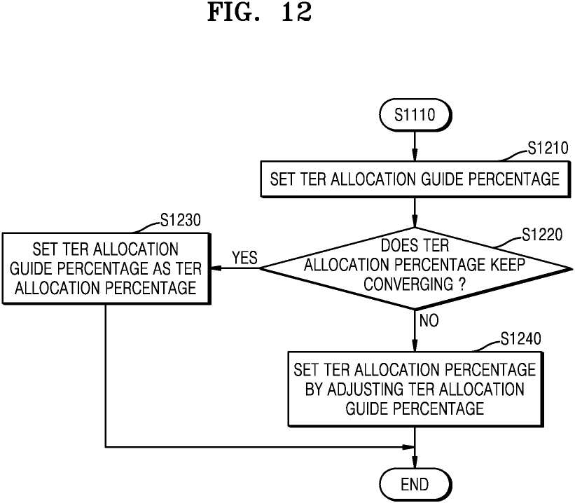

Referring to FIG. 10, in operation S1010, the controller 130′ may set a TER allocation percentage based at least in part on whether the electronic device 100 is using only one communication network. A method, performed by the controller 130′, of setting a TER allocation percentage may be as shown in more detail in FIGS. 11 and 12.

FIGS. 11 and 12 are flowcharts illustrating in more detail a method, performed by an electronic device, of setting a TER allocation percentage, according to another embodiment.

First, referring to FIG. 11, in operation S1110, the controller 130′ may determine whether the electronic device 100 is using only one communication network.

When it is determined that the electronic device 100 is using one communication network, the controller 130′ may perform operation S1120 to determine whether the electronic device is operating in a dual SIM mode.

When it is determined that the electronic device 100 is operating in the dual SIM mode, the controller 130 may perform operation S1130 to set a dual SIM TER allocation percentage as a TER allocation percentage.

When it is determined that the electronic device 100 is not operating in the dual SIM mode, the controller 130 may perform operation S1140 to set a TER allocation percentage by taking into account the effect of a communication network being not used.

When it is determined that the electronic device 100 is not using one communication network, the controller 130′ may perform operation S1210 of FIG. 12.

Referring to FIG. 12, in operation S1210, the controller 130′ may set a TER allocation guide percentage. The controller 130′ may set a TER allocation guide percentage for a plurality of communication networks based on TER usage percentages for the plurality of communication networks in a window preceding a target window.

In operation 1220, the controller 130′ may determine whether a TER allocation percentage for each of the communication networks keeps converging.

When it is determined that the TER allocation percentage keeps converging, the controller 130′ may perform operation S1230 to set a TER allocation guide percentage as the TER allocation percentage.

On the other hand, when it is determined that the TER allocation percentage does not keep converging, the controller 130′ may perform operation S1240 to set the TER allocation percentage by adjusting the TER allocation guide percentage.

Returning to FIG. 10, in operation S1020, the controller 130′ may calculate a residual TER value, based on transmit power and a TER allocation percentage.

For each of the plurality of communication networks, the controller 130′ may calculate a slot TER value based on the transmit power, calculate a window TER value by summing together a plurality of slot TER values, and calculate a residual TER value, based on a TER allocation percentage, a window TER value, and a limited TER value. In this case, the controller 130′ may calculate an accumulated TER value by summing together a plurality of window TER values and then calculate a residual TER value by subtracting the accumulated TER value from a value obtained by multiplying a TER allocation percentage of the corresponding communication network by the limited TER value.

In operation S1030, the controller 130′ may set a power control mode of the electronic device 100, based on the residual TER value and a first reference TER value. The controller 130′ may set a power control mode for each of the communication networks, and a specific method of setting a power control mode may be substantially the same as that described above with reference to operation S520 of FIG. 5.

In operation S1040, the controller 130′ may set a transmit power limit for the target window based on the power control mode. The controller 130′ may set a transmit power limit for each of the communication networks, and a specific method of setting a transmit power limit may be substantially the same as that described above with reference to operation S530 of FIG. 5.

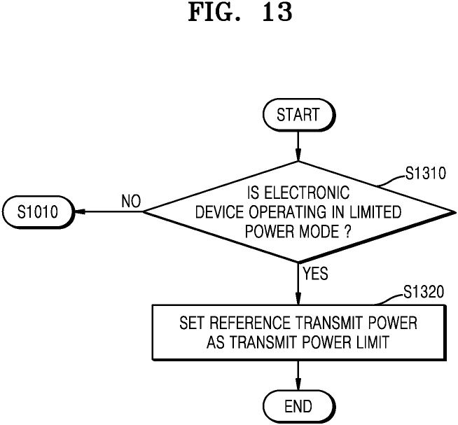

FIG. 13 is a flowchart of an operation when an electronic device is operating in a limited power mode, according to another embodiment.

Referring to FIG. 13, before operation S1010 of FIG. 10, in operation S1310, the controller 130 may determine whether the electronic device 100 is operating in a limited power mode.

When the electronic device 100 is not operating in the limited power mode, the controller 130 may perform operation S1040 of FIG. 10 to set a transmit power limit for the target window by using the same method as described above with reference to FIGS. 10 to 12.

When the electronic device 100 is operating in the limited power mode, the controller 130 may perform operation S1320 to set a reference transmit power for the target window as a transmit power limit for the target window. In other words, when the electronic device 100 is operating in the limited power mode, the transmit power limit for the target window may be set in a different manner than that described above with reference to FIGS. 10 to 12.

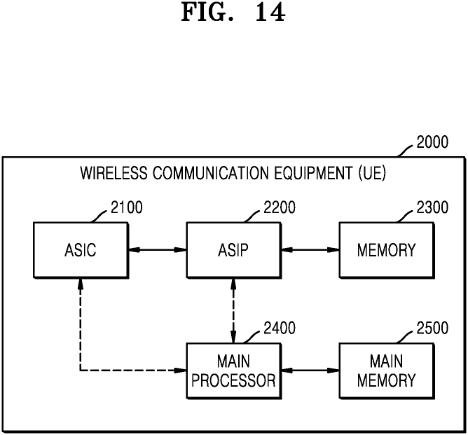

FIG. 14 is a block diagram of a wireless communication equipment according to an embodiment.

Referring to FIG. 14, a wireless communication equipment (or a user equipment (UE)) 2000 may include an application specific integrated circuit (ASIC) 2100, an application specific instruction set processor (ASIP) 2200, a memory 2300, a main processor 2400, and a main memory 2500. Two or more of the ASIC 2100, the ASIP 2200, and the main processor 2400 may communicate with each other. Furthermore, at least two of the ASIC 2100, the ASIP 2200, the memory 2300, the main processor 2400, and the main memory 2500 may be embedded in a single chip.

The ASIC 2100 is an integrated circuit customized for a particular use, and may include, for example, an RFIC, a modulator, a demodulator, etc. The ASIP 2200 may support a dedicated instruction set for a particular application and execute instructions included in the instruction set. The memory 2300 may communicate with the ASIP 2200 and store, as a non-volatile storage device, a plurality of instructions executed by the ASIP 2200. For example, the memory 2300 may include any type of memory accessible by the ASIP 2200, such as random access memory (RAM), read-only memory (ROM), magnetic tape, a magnetic disk, an optical disk, a volatile memory, a non-volatile memory, and any combination thereof.

The main processor 2400 may control the UE 2000 by executing a plurality of instructions. For example, the main processor 2400 may control the ASIC 2100 and the ASIP 2200 and process data received over a wireless communication network or a user input to the UE 2000. The main memory 2500 may communicate with the main processor 2400 and store, as a non-transitory storage device, a plurality of instructions executed by the main processor 2400. For example, the main memory 2500 may include any type of memory accessible by the main processor 2400, such as RAM, ROM, magnetic tape, a magnetic disk, an optical disk, a volatile memory, a non-volatile memory, and any combination thereof.

The components of the electronic device 100 or operations of the operation method of the electronic device 100 according to the embodiments described above may be included in at least one of the components included in the wireless communication equipment 2000 of FIG. 14. For example, the electronic device 100 of FIG. 1 or at least one operation of the operation method of the electronic device 100 may be implemented as a plurality of instructions stored in the memory 2300, and the ASIP 2200 may perform an operation of the electronic device 100 or at least one operation of the operation method by executing the plurality of instructions stored in the memory 2300. In another example, the electronic device 100 of FIG. 1 or at least one operation of the operation method of the electronic device 100 may be implemented as a hardware block and included in the ASIC 2100. In another example, the electronic device 100 of FIG. 1 or at least one operation of the operation method of the electronic device 100 may be implemented as a plurality of instructions stored in the main memory 2500, and the main processor 2400 may perform the electronic device 100 or the at least one operation of the operation method of the electronic device 100 by executing the plurality of instructions stored in the main memory 2500.

Embodiments have been set forth above in the drawings and the specification. Although embodiments have been described using specific terms in the present specification, these are used only for the purpose of explaining the technical spirit of the inventive concept, and are not used to limit the meaning or the scope of the inventive concept set forth in the claims. Therefore, those of ordinary skill in the art would understand that various changes in form and details may be made therein and equivalent other embodiments are possible therefrom. Accordingly, the true scope of the inventive concept should be defined by the technical idea of the appended claims.

While the inventive concept has been particularly shown and described with reference to embodiments thereof, it will be understood that various changes in form and details may be made therein without departing from the spirit and scope of the following claims.

What is claimed is:

1. An electronic device comprising:
a plurality of antennas;
a transmitter configured to be selectively connected to at least one antenna of the plurality of antennas; and
a controller configured to:
set a transmit power limit of the transmitter;
calculate a residual total exposure ratio (TER) value for a TER measurement period based on transmit power of the transmitter output through the at least one antenna;
set a power control mode of the electronic device, based on a comparison between the residual TER value and a first reference TER value; and
set the transmit power limit for a target window based on the power control mode.

2. The electronic device of claim 1, wherein the TER measurement period is set based on a communication frequency band for the electronic device.

3. The electronic device of claim 1, wherein each of a plurality of windows within the TER measurement period is composed of a plurality of slots, and the controller is further configured to:
for each window of the plurality of windows, calculate respective slot TER values for the plurality of slots of the window, based on transmit power of the transmitter;
calculating a plurality of window TER values, each of the window TER values being calculated by summing together the slot TER values for the plurality of slots included in the window; and
calculate the residual TER value, based on the plurality of window TER values and a limited TER value.

4. The electronic device of claim 3, wherein the controller is further configured to:
calculate an accumulated TER value by summing together the plurality of window TER values respectively corresponding to the plurality of windows included in the TER measurement period; and
calculate the residual TER value by subtracting the accumulated TER value from the limited TER value.

5. The electronic device of claim 1, wherein the controller is further configured to:
set the power control mode based on a change in window TER values within the TER measurement period when the residual TER value is greater than or equal to the first reference TER value; and
set the power control mode as a power saving mode when the residual TER value is less than the first reference TER value.

6. The electronic device of claim 5, wherein the change in the window TER values within the TER measurement period is calculated based on the window TER values, a correlation coefficient between the plurality of antennas, and a back-off TER value.

7. The electronic device of claim 5, wherein the controller is further configured to:
set a pre-saving mode as the power control mode when the window TER value is increasing within the TER measurement period; and
set a maximum power mode as the power control mode when the window TER value is decreasing within the TER measurement period.

8. The electronic device of claim 1, wherein
the controller is further configured to
set an available TER value for the target window based on the power control mode, and
set the transmit power limit based on the available TER value.

9. The electronic device of claim 8, wherein the controller is further configured to:
set the available TER value, based on a second reference TER value and a third reference TER value, when the power control mode is a power saving mode;
set the available TER value to a back-off TER value when the power control mode is a pre-saving mode; and
set a required TER value as the available TER value when the power control mode is a maximum power mode; and
wherein the second reference TER value is less than the first reference TER value, and the third reference TER value is less than the second reference TER value.

10. The electronic device of claim 9, wherein the controller is further configured to:
when the power control mode is the power saving mode:
set the available TER value to the back-off TER value when the residual TER value is greater than or equal to the second reference TER value;
set, as the available TER value, a value obtained by multiplying the back-off TER value by a ratio of the residual TER value to the first reference TER value when the residual TER value is less than the second reference TER value but is greater than or equal to the third reference TER value; and
set the available TER value to a minimum TER value when the residual TER value is less than the third reference TER value.

11. An electronic device comprising:
a plurality of antennas;
a transmitter configured to be selectively connected to at least one of the plurality of antennas; and
a controller configured to:
set a transmit power limit of the transmitter;
set a total exposure ratio (TER) allocation percentage for a plurality of communication networks based at least in part on whether the electronic device is using only one of the plurality of communication networks;
calculate, for each of the plurality of communication networks, a residual TER value for a TER measurement period, based on transmit power of the transmitter and the TER allocation percentage;
set, for each of the plurality of communication networks, a power control mode of the electronic device, based on a comparison between the residual TER value and a first reference TER value; and
set, for each of the plurality of communication networks, the transmit power limit for a target window based on the power control mode.

12. The electronic device of claim 11, wherein the controller is further configured to:
determine whether the electronic device is operating in a dual SIM mode when the electronic device is using only one communication network;
when the electronic device is not operating in the dual SIM mode, set the TER allocation percentage by taking into account an effect of a communication network that is not being used; and
when the electronic device is operating in the dual SIM mode, set a preset dual SIM TER allocation percentage as the TER allocation percentage.

13. The electronic device of claim 11, wherein the controller is further configured to:
when the electronic device is using a plurality of communication networks, set a TER allocation guide percentage for the plurality of communication networks based on a TER usage percentage for the plurality of communication networks in a window preceding the target window; and
set the TER allocation percentage, based on the TER allocation guide percentage and whether the TER allocation percentage keeps converging.

14. The electronic device of claim 13, wherein the controller is further configured to:
when the electronic device is using the plurality of communication networks:
set the TER allocation percentage by adjusting the TER allocation guide percentage when the TER allocation percentage does not keep converging; and
set the TER allocation guide percentage as the TER allocation percentage when the TER allocation percentage keeps converging.

15. The electronic device of claim 11, wherein the controller is further configured to:
calculate, for each of the plurality of communication networks, slot TER values based on transmit power of the at least one of the plurality of antennas;
calculate, for each of the plurality of communication networks, a window TER value by summing together the slot TER values for a plurality of slots included in a window; and
calculate, for each of the plurality of communication networks, the residual TER value, based on the TER allocation percentage, the window TER value, and a limited TER value.

16. The electronic device of claim 15, wherein the controller is further configured to:
calculate, for each of the plurality of communication networks, an accumulated TER value by summing together window TER values respectively corresponding to a plurality of windows included in the TER measurement period; and
calculate, for each of the plurality of communication networks, the residual TER value by subtracting the accumulated TER value from a value obtained by multiplying the TER allocation percentage of the communication network by the limited TER value.

17. The electronic device of claim 11, wherein the controller is further configured to:
set an instantaneous maximum TER value and a controlled TER value for each of the plurality of communication networks;
set, for each of the plurality of communication networks, an available TER value for the target window based on the power control mode; and
set, for each of the plurality of communication networks, the transmit power limit based on the available TER value.

18. The electronic device of claim 17, wherein the controller is further configured to, after setting the available TER value based on the power control mode, reset a minimum value among the available TER value, the instantaneous maximum TER value, and the controlled TER value as the available TER value for each of the plurality of communication networks.

19. The electronic device of claim 11, wherein the controller is further configured to:
before determining whether the electronic device is using only one communication network, determine whether the electronic device is operating in a limited power mode, and when the electronic device is operating in the limited power mode, set preset reference transmit power as the transmit power limit.

20. An operation method of an electronic device including a plurality of antennas, a transmitter configured to be selectively connected to at least one of the plurality of antennas, and a controller configured to set a transmit power limit of the transmitter, the operation method comprising:
performing, by the controller, operations comprising:
calculating slot total exposure ratio (TER) values based on transmit power of the electronic device;
calculating a window TER value by summing together the slot TER values for a plurality of slots included in a window;
calculating a residual TER value for a TER measurement period, based on the window TER value and a limited TER value;
setting a power control mode of the electronic device, based on a comparison between the residual TER value and a first reference TER value;
setting an available TER value for a target window based on the power control mode; and
setting the transmit power limit for the target window based on the available TER value for the target window.
